(19) United States
(12) Patent Application Publication
(10) Pub. No.: US 2008/0196926 A1
(43) Pub. Date: Aug. 21, 2008

(54) Copper clad ballast wire

(76) Inventor: Kevin Yang, Palos Verdes Estates, CA (US)

Correspondence Address: LAW OFFICES OF CLEMENT CHENG, 17220 NEWHOPE STREET #127, FOUNTAIN VALLEY, CA, 92708, US

(21) Appl. No.: 11/707,679

(22) Filed: Feb. 17, 2007

(51) Int. Cl. H01B 5/00

(52) U.S. Cl. 174/126.2

(57) ABSTRACT

Copper clad wire for ballast of fluorescent lamps is disclosed as having a core wire of a lower priced metal core than copper and a copper coating fixed on the core wire by means of a thin diffusion layer.

### BACKGROUND OF THE INVENTION

A. Field of the Invention

The present invention relates to an electric conductor. More particularly, the present invention relates to a copper clad lead wire for fluorescent lamps.

B. Discussion of Related Art

In modern life, fluorescent lighting is widely used in office buildings, shopping centers, warehouses, libraries and school classrooms. Fluorescent lamps have special operating characteristics, each fluorescent lamp must have a ballast to make it work properly. Not each lamp has to have a ballast to work with. Due to the availability of high-voltage and high-current semiconductors, most electronic ballast is able to drive multiple lamps and some specially designed ballasts are able to drive up to four lamps. Therefore, today's ballasts require more lead wires. Some rapid start ballast lead wire can be up to as long as 36′. The lead wires thus become a significant design consideration.

In the US lighting industry, by the National Electrical Code, all ballast lead wires are to be attached to each individual ballast, either for electronic ballast or electric-magnetic ballast. In addition, by the Code, at least #18 gauge (about 0.92 mm) or thicker solid insulated wire must be used as the lead wires for all ballast no matter how small the ballast is. It would still apply to a tiny ballast with the case dimension as little as 3.0″L×1.0″W×1.0″H, which only drives one 7 W mini fluorescent lamp. The regulation also is suitable for a big ballast, which has a case dimension as big as 11.8″L×3.3″W×2.5″H, and is capable of driving multiple high output lamps (up to 110 W each) with the input wattage of up to 240 W.

Theoretically, lead wire with a length of up to 60 inches and made of #18 gauge pure copper solid wire would be able to carry over 10 Amps of electrical current. Most ballast, which is widely used for interior lighting, only has a fraction of an ampere of electrical current running through the lead wires. Even for the most powerful HO (high output) ballasts, which are able to drive two 8 feet 110 W fluorescent lamps, the ballasts' output lamp current is still less than one ampere, and the maximum input current is about two Amps.

The reasons for the mandatory use of the gauge #18 wires for all ballast's lead wire is as follows:
(1) In the past, most US standard electrical-magnetic ballast were made of a bundle of steel laminations combined with heavy copper coils, and they are bulky and very heavy. They weighed over a few pounds each. People sometimes need to hold the ballast by the lead wire to move it from one place to another, and the lead wire could be broken if it was not mechanically strong enough. Even in today's electronic ballast, though the comparably powered ballast's size and weight have been reduced significantly, most of them still weigh over a pound. Therefore, oversized, heavy-duty and stronger #18 gauge wires must be specified for all ballast lead wires.
(2) Many other wiring needed electrical parts, such as lamp holders, switches, multi-wire connectors, and outlets built with a “snap-in plus self-lock” structure. This kind of structure is cost effective, simple, reliable and easy to use. However, it does require at least #18 gauge solid wires to be securely connected to each other. These handy locking connections could result in bad connections if less than #18 gauge wires were used, and as the direct consequences it could create significant safety and reliability issues.

Therefore, it is an object of this invention to improve a fluorescent ballast by improving the lead wire within the confines of the electrical code, while following the #18 gauge requirement for connecting the ballast. Copper clad ballast lead wire may or may not be more economical when used in the present invention for connecting multiple fluorescent lamps in parallel. Thus, a second object of the present invention is to configure ballast lead wire in such a way that the manufacturing and installation costs will actually be less than the cost of the copper used.

### SUMMARY OF THE INVENTION

The present invention relates to copper clad wire for ballast of fluorescent lamps, the copper clad wire having a core wire with a copper coating in order to save the relatively expensive copper material without compromising safety stipulations of the US and other comparable electrical regulations, and to a method for manufacturing such copper wire.

The present invention provides a novel ballast lead wire, which is capable of safely carrying up to 2 amperes of electronic current. Specifically, the present invention uses as the core for ballast lead wire either a copper-clad iron including steel or copper-clad aluminum, which could be one of copper-clad conductors of any other alloys to save the cost of material such as copper. Copper clad iron and copper clad aluminum can be as mechanically strong as copper. Copper clad over lower cost metal can take the advantage of the electrical conductivity of copper and its soldering-ability while eliminating the waste of using excessive pure copper. The substituted metal material, of course, should be much cheaper than copper. Thus, it is one of effective ways to reduce ballast's material cost.

The lead wire may have a larger diameter for a comparable cost resulting in more energy efficient wiring of the space or the whole building system. In fact, for metal wire, the larger the diameter of the wire the lower the electrical resistance by the wire meaning corresponding reduction of wasted energy by the circuit. Lighting systems typically consist of permanently wired-in lighting fixtures, with each lighting fixture obtaining its power directly from a regular Class 1 power line.

The copper cladding is drawn from a solid copper wire through a die so that the copper cladding envelops a wire core of their material such as iron or aluminum. A copper coating is fixed on this core wire with the aid of a thin diffusion layer. The core metal to be used is preferably steel or aluminum, with aluminum being the best mode where great mechanical strength is not required. The tolerance should be approximately 3%.

The core metal is drawn through a die together with the copper, and thus electrolytic methods are not required for joining the metals. The core and cladding are joined together by working and annealing to produce the thin diffusion layer on the interface between the metals. The copper cladding should have a very thin wall, made by extrusion. Embodiments of the invention will now be described by way of example with reference to the accompanying drawings.

### BRIEF DESCRIPTION OF THE DRAWINGS

FIG. 1 is a cross section view of the lead wire according to the present invention.

FIG. 2 is an assembly diagram for the lead wire according to a first method.

FIG. 3 is a front view of a typical die for making cladding on lead wire according to the first method.

FIG. 4 is a view of a ballast having copper clad lead wire.

Similar reference numbers denote corresponding features throughout the attached drawings.

### DETAILED DESCRIPTION OF THE PREFERRED EMBODIMENT

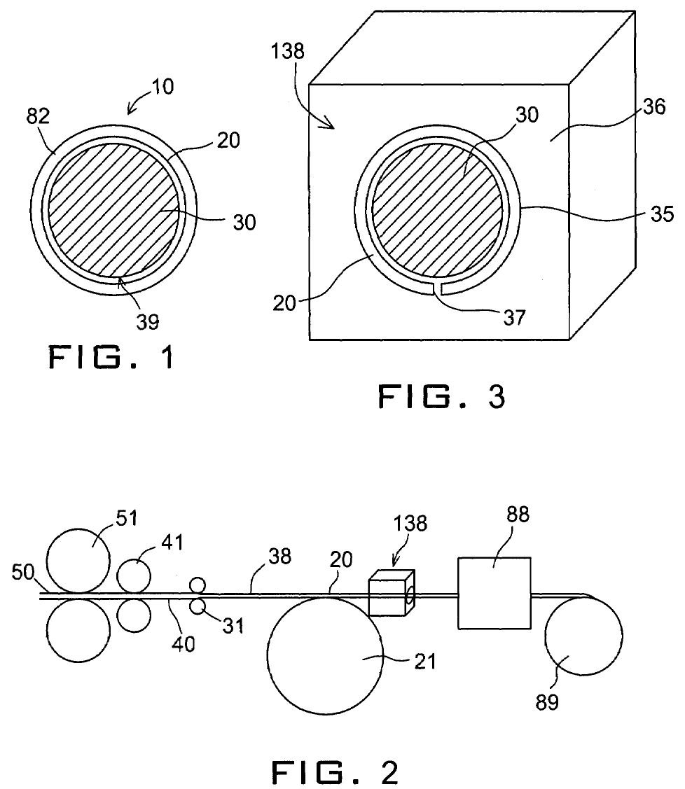

With reference to FIG. 1, ballast lead wire 10 has a core 30 of aluminum, stainless steel, or other iron core and has a cladding 20 made of copper. The installation layer 82 protects the wire 10. The copper clads around the steel and may optionally have a seam 39 the seam 39 prevents overlap and waste of copper.

In a first method, the copper is added when the lead wire is almost at the final diameter. As seen in FIG. 2, the production process diagram begins with large diameter core wire 50 that passes through large rollers 51 and intermediate rollers 41 providing a medium diameter wire. Instead of large diameter rollers 51 and intermediate diameter rollers 41, the wire can be drawn through a die also. Intermediate diameter wire 40 can further be drawn or rolled by rollers 31 into the almost final size core wire 38. The almost final size core wire 38 is only slightly larger than the final size core wire 30. A spool of copper cladding 21 unwinds copper cladding 20 that passes through a die 138 with the core wire 30.

As seen in FIG. 3, the die 138 has a central portion drawing the core wire 30 and an external gap 35 receiving the copper cladding 20. Optionally, a spacer 37 makes a seam 39. The copper cladding is drawn through and pressed against the sides of the core wire so that the core wire is drawn down to the final size core wire 30. The exit face of the die 36 provides the final configuration of the cladded wire 10. The wire 10 passes through final treatment process 88, such as annealing, heating, surface treatment, addition of electrolytic layers, addition of installation or any other well-known steps before being wound into a final spool 89.

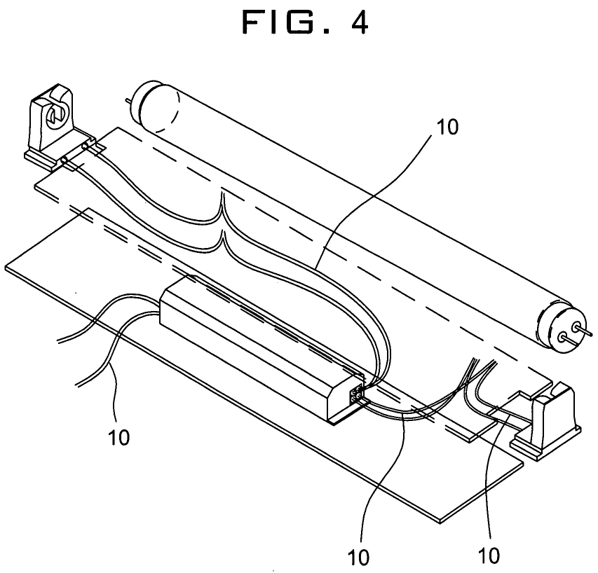

The final spool 89 is then shipped to the ballast assembly area. The ballast assembly workers then cut the wire 10 to appropriate lengths before installing the wire in lead wire locations as shown in FIG. 4.

In a second method for making the copper clad lead wire, the copper also be added in the beginning when the core wire is still a large diameter core wire 50. Instead of adding the copper cladding at the last stage which would require a die for joining the copper to the core, the same copper clad lead wire can be formed in the beginning by starting with a core rod such as a stainless steel or aluminum rod that is about 1 cm in thickness. A copper tube having the same inside diameter fits over the core rod. The thickness of the copper tube and the core rod are determined so as to correspond to the cross-sectional proportions in the final dimension.

Thereafter, the copper tube and the core rod are drawn together through several successive drawing stages and drawing rings. The process would be analogous to the one shown in FIG. 2 where the large diameter wire is pressed through successive rolling or drawing large-size rings 51 toward smaller diameter rolling or drawing rings 41 until the material is of the final size. When the material is on final size, the copper is pressed tightly onto the core. If this mechanical interface is not sufficient the material is treated by diffusion annealing which involves heating to a suitable temperature and within a suitable time, so that a slight and very thin diffusion is achieved. After the diffusion annealing, or several diffusion annealings if necessary, the material is drawn out to its final thickness, which is 18 gauge. The wire can be used as such or soft annealed, in which case excessive diffusion should again be avoided. Therefore, while the presently preferred form of the invention has been shown and described, and several modifications thereof discussed, persons skilled in this art will readily appreciate that various additional changes and modifications may be made without departing from the spirit of the invention, as defined and differentiated by the following claims.

The third embodiment of the present invention is use of electroplating core wire comprising either stainless steel wire aluminum or a suitable material like stainless steel or aluminum. Core wire can be electroplated with copper. This embodiment is not as preferable due to the increased cost. In any case the best mode copper thickness is 0.07 mm. It is to be understood that the present invention is not limited to the sole embodiment describe above, but encompasses any and all embodiments within the scope of the following claims.

1. A ballast for a florescent lamp having copper clad wire comprising: a lead wire comprising a metal wire core at a diameter of about 18 gauge and a copper cladding substantially enveloping over the metal core.

2. The ballast for a florescent lamp having copper clad wire of claim 1, wherein the metal wire core is an aluminum wire core.

3. The ballast for a florescent lamp having copper clad wire of claim 2, further comprising: an electronic ballast having lead wires connected to electrical connections adapted to receive a fluorescent lamp.

4. The ballast for a florescent lamp having copper clad wire of claim 3, wherein the lead wire is made by the process of: firstly forming an about 18 gauge wire core, then electroplating the wire core with copper.

5. The ballast for a florescent lamp having copper clad wire of claim 3, wherein the lead wire is made by the process of: firstly forming a large diameter rod by assembly of an aluminum rod with a copper tube fitting over the aluminum rod, secondly drawing down the large diameter rod into a small diameter rod into a first drawing, thirdly drawing down the small diameter rod into 18 gauge wire in a third drawing.

6. The ballast for a florescent lamp having copper clad wire of claim 5, wherein the lead wire is insulated and the copper thickness is 0.07 mm.

7. The ballast for a florescent lamp having copper clad wire of claim 3, wherein the lead wire is made by the process of: firstly drawing down an aluminum rod to make aluminum wire core that is slightly more than 18 gauge, secondly drawing copper into a sheath over the aluminum wire core, thirdly drawing the copper over the aluminum wire core.

8. The ballast for a florescent lamp having copper clad wire of claim 7, wherein the lead wire is further made by the process of: at least one diffusion annealing step.

9. The ballast for a florescent lamp having copper clad wire of claim 7, wherein the copper cladding has a seam.

10. The ballast for a florescent lamp having copper clad wire of claim 1, wherein the metal wire core is a steel wire core.

11. The ballast for a florescent lamp having copper clad wire of claim 10, further comprising: an electronic ballast having lead wires connected to electrical connections adapted to receive a fluorescent lamp.

12. The ballast for a florescent lamp having copper clad wire of claim 11, wherein the lead wire is made by the process of: firstly forming a large diameter rod by assembly of a steel rod with a copper tube fitting over the steel rod, secondly drawing down the large diameter rod into a small diameter rod into a first drawing, thirdly drawing down the small diameter rod into 18 gauge wire in a third drawing.

13. The ballast for a florescent lamp having copper clad wire of claim 12, wherein the lead wire is insulated.

14. The ballast for a florescent lamp having copper clad wire of claim 11, wherein the lead wire is made by the process of: firstly drawing down a steel rod to make steel wire core that is slightly more than 18 gauge, secondly drawing copper into a sheath over the steel wire core, thirdly drawing the copper over the steel wire core.

15. The ballast for a florescent lamp having copper clad wire of claim 11, wherein the lead wire is further made by the process of: at least one diffusion annealing step.

16. The ballast for a florescent lamp having copper clad wire of claim 11, wherein the copper cladding has a seam.
